(19) United States
(12) Patent Application Publication
(10) Pub. No.: US 2026/0194387 A1
(43) Pub. Date: Jul. 9, 2026

(54) PORTABLE SCALE

(71) Applicant: AOB Products Company, Columbia, MO (US)

(72) Inventors: Dennis W. Cauley, Jr., Fayette, MO (US); Timothy S. Kinney, Warrenton, MO (US); Max Willoughby, Columbia, MO (US); Kyle Martin, Columbia, MO (US); Russell Bergeron, Columbia, MO (US); Mark Dalton, Columbia, MO (US); James Tayon, Moberly, MO (US); Todd Strobel, Columbia, MO (US)

(73) Assignee: AOB Products Company, Columbia, MO (US)

(21) Appl. No.: 19/444,383

(22) Filed: Jan. 9, 2026

Related U.S. Application Data
(60) Provisional application No. 63/743,417, filed on Jan. 9, 2025.

(51) Int. Cl. G01G 19/18; G01G 21/28

(52) U.S. Cl. CPC G01G 19/18; G01G 21/283

(57) ABSTRACT

A handheld scale and associated components and methods. The handheld scale includes a handle having a battery compartment. The handle has a gripping section configured to be grasped by a hand of a user to support the scale when weighing an object. A head is supported by the handle. The head includes a display. A weight sensor is supported by the handle and measures a weight of the object. A battery storage cover is moveable between a closed position where the battery storage cover closes the battery compartment and an open position where the battery storage cover is arranged to permit access to the battery compartment.

### CROSS-REFERENCE TO RELATED APPLICATION

This application claims priority to U.S. Provisional Ser. No. 63/743,417, filed Jan. 9, 2025, the entirety of which is incorporated herein by reference.

### FIELD

The present disclosure relates generally to portable scales, and more particularly to hand-held fish scales.

### BACKGROUND

Handheld weighing scales (also called portable scales) are used by fisherman to measure the weight of a fish.

### SUMMARY

In one aspect, a handheld scale comprises a handle having a battery compartment. The handle has a gripping section configured to be grasped by a hand of a user to support the scale when weighing an object. A head is supported by the handle. The head includes a display. A weight sensor is supported by the handle. The weight sensor is configured to measure a weight of the object. A battery storage cover is moveable between a closed position where the battery storage cover closes the battery compartment and an open position where the battery storage cover is arranged to permit access to the battery compartment. The battery storage cover is arranged to be engaged by the hand of the user when the hand is grasping the gripping section to support the scale when weighing the object.

In another aspect, a handheld scale comprises a handle having a battery compartment. The handle has a gripping section configured to be grasped by a hand of a user to support the scale when weighing an object. A head is supported by the handle. The head includes a display. A weight sensor is supported by the handle. The weight sensor is configured to measure a weight of the object. A battery storage cover is moveable between a closed position where the battery storage cover closes the battery compartment and an open position where the battery storage cover is arranged to permit access to the battery compartment. The battery storage cover is configured to form an interference fit with the handle for locating the battery storage cover relative to the handle in the closed position. The interference fit creates a seal to obstruct water from entering the battery compartment past the seal.

In another aspect, a handheld scale comprises a handle configured to be grasped by a hand of a user to support the scale when weighing an object. A weight sensor is supported by the handle. The weight sensor is configured to measure a weight of the object. A user interface is supported by the handle. The user interface includes a display configured to display the weight measured by the weight sensor. The scale includes a wireless communication port and a controller. The wireless communication port communicates with a remote device. The controller is configured to receive a control signal from the remote device via the wireless communication port. The controller is configured to modify at least one of a setting or a mode of the handheld scale in response to receiving the control signal.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

FIG. 1 is a schematic diagram of a portable scale system according to one embodiment of the present disclosure;

FIG. 2 is a perspective of a portable scale of the portable scale system;

FIG. 3 is an enlarged, fragmentary perspective of a battery storage cover removed and separated from a handle of the portable scale;

FIG. 4 is a bottom perspective of the battery storage cover;

FIG. 5 is an exploded view of the battery storage cover;

FIG. 6 is a perspective of a rigid brace of the battery storage cover;

FIG. 7 is a perspective view of an elastomeric shell of the battery storage cover; and

FIG. 8 is a side view illustrating an example display orientation relative to the handle axis.

Corresponding reference numbers indicate corresponding parts throughout the drawings.

### DETAILED DESCRIPTION

The present disclosure relates to a handheld or portable scale that includes an ergonomically designed handle, a head, and a battery storage cover (battery compartment cover). The portable scale may be configured as a fish scale for weighing fish and has the ability to communicate wirelessly with external devices, such as smartphones. The head includes an angled display that enables a user to comfortably view the display while holding the scale in a proper vertical holding orientation. Furthermore, the battery storage cover forms a watertight interference fit without requiring threaded connections or complicated latching mechanisms. In addition, the portable scale has bi-directional wireless control capabilities that enable a user to modify settings and/or modes of the scale remotely from the scale.

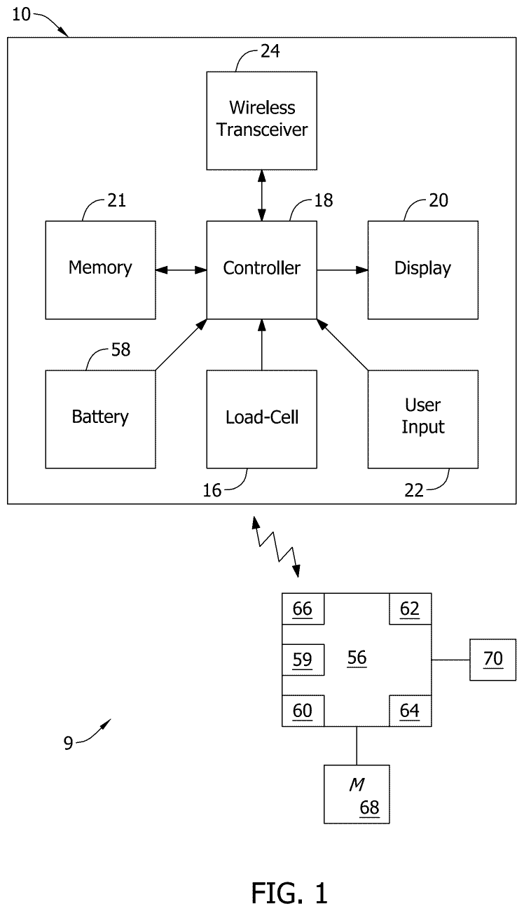

Referring to FIG. 1, one embodiment of the portable scale system 9 according to the present disclosure is schematically shown. The portable scale system 9 includes a portable scale 10 and a remote device 56.

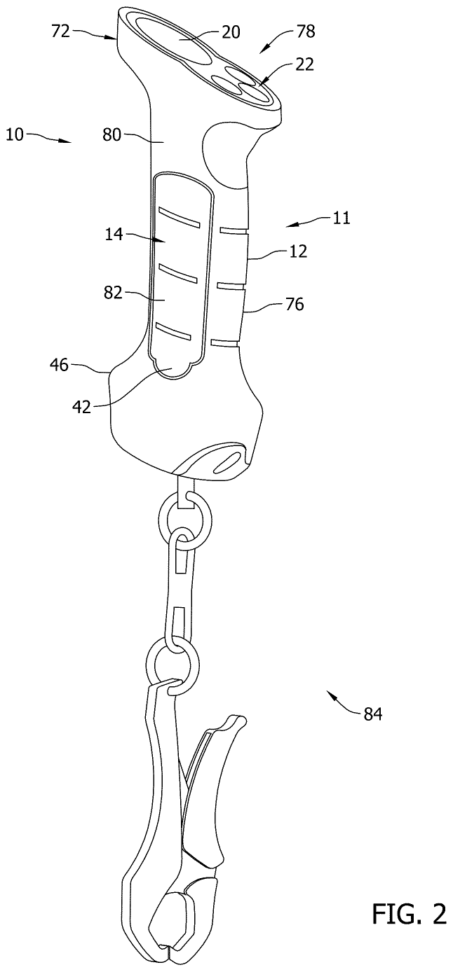

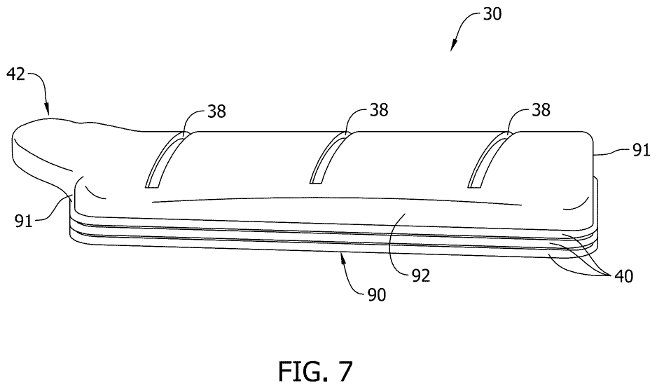

Referring to FIGS. 2-8, the portable scale 10 (broadly, electronic device or handheld electronic device) is configured as, but is not limited to only being used as, a handheld fish scale for use in weighing fish in tournaments and recreational fishing applications. The portable scale 10 includes an ergonomically designed handle 11, a head 72, and a battery storage cover 14. The portable scale 10 also includes a load cell 16 (broadly, weight sensor) for use in measuring weight, a controller 18, a display 20, user input 22 (e.g., button(s)), and a communication port 24, such as a wireless communication port (e.g., a wireless transceiver) that enables bi-directional communication with external devices 56 remote of the scale 10 such as a smartphone, for example.

The head 72 has an angled display 20 that enables and promotes a proper vertical holding orientation and comfortable viewing. Desirably, the battery storage cover 14 forms a watertight interference fit without requiring threaded connections or latching mechanisms. The bi-directional wireless control capability that enables a remote device 56 to modify settings and modes of the scale. Other configurations can be used without departing from the scope of the present disclosure.

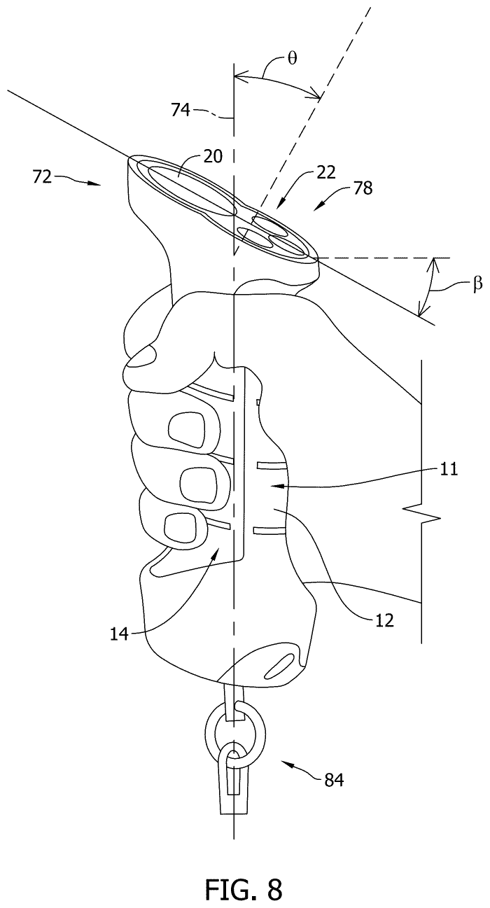

The handle 11 is grasped by a hand of the user to support the scale 10 when weighing an object (e.g., fish). The handle 11 includes a gripping section 12 configured to be grasped by the hand of the user to support the scale 10 when weighing the object. The gripping section 12 is generally cylindrical and is designed to be grasped and held in a vertical orientation by a user's hand. The generally cylindrical shape provides a comfortable and secure gripping area for the user during weighing operations. In alternative embodiments, the gripping section may have any other shape, including non-cylindrical shapes, that enables the gripping section 12 to function as described herein. The handle 11 is defined by a handle axis 74 (FIG. 8) that extends generally longitudinally through a center of the generally cylindrical gripping section 12. Moreover, the handle 12 has a construction that includes a rigid inner body 44 (e.g., formed of plastic, such as injection-molded plastic) surrounded by an outer covering 46. The rigid inner body 44 provides structural support, while the outer covering 46 provides a comfortable, non-slip gripping surface. The outer covering 46 may be made of, but is not limited to only being fabricated from, a thermoplastic elastomer (TPE) material, a rubber material, a silicone material, and/or any other suitable elastomeric material or combination of materials that enables the handle 12 to function as described herein. The outer covering 46 forms most of the exterior surfaces of the handle 11.

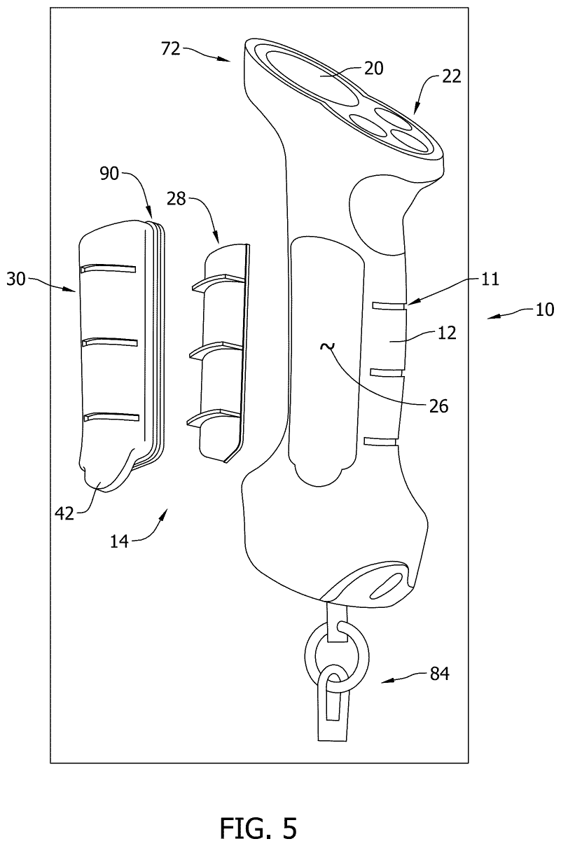

The handle 12 has a battery compartment 26 sized and shaped to receive at least one battery 58 therein. In one embodiment, the battery compartment 26 is sized and oriented to receive AA battery cells therein. In another embodiment, the battery compartment 26 is sized and oriented to receive a lithium battery pack therein. The battery compartment 26 has an opening 27 that is sized and shaped to enable batteries 58 to be inserted into and removed from the battery compartment. The battery storage cover 14 is moveable between a closed position (FIG. 2) and an open position (FIG. 5). In the closed position, the battery storage cover 14 closes the battery compartment 26 (e.g., closes the compartment opening 27). In the closed position, the battery storage cover 14 can be inserted into (e.g., fully inserted into) and sealed against the handle 11. In the illustrated embodiment, in the closed position an outer surface of the battery cover forms a grip of the scale with the outer surface of the gripping section 12 of the handle 11. In the open position, the battery storage cover 14 is arranged to permit access to the battery compartment 26. This allows a user to replace the batteries 58 in the battery compartment 26. In the illustrated embodiment, the battery storage cover 14 is free from connection to (not attached directly or indirectly through other components) the handle 11 when in the open position. The battery storage cover 14 is separate from the handle 11 and can move independently of the handle. Other configurations (e.g., hinged cover to handle) can be used without departing form the scope of the present disclosure.

In the illustrated embodiment, the gripping section 12 includes ergonomic contours that facilitate promoting an optimal grip and enhanced control for a user during weighing operations ranging from light to heavy loads.

The handle 11 can include a shoulder or lip 48 that essentially functions as a stop and that is positioned within or adjacent to the battery compartment 26. The shoulder 48 is oriented to engage the battery storage cover 14 when the battery storage cover 14 is being secured to the handle 11, and thus limits or stops further insertion of the battery storage cover 14 into the handle. As such, the shoulder 48 positions the battery storage cover 14 in the proper orientation in the closed position. Accordingly, the shoulder 48 facilitates consistent and repeatable positioning of the battery storage cover 14 relative to the handle 11. In the illustrated embodiment, the shoulder 48 extends around the entire perimeter of the battery compartment 26. In other embodiments, the shoulder may only extend around a portion or portions of the battery compartment.

In the illustrated embodiment, the battery storage cover 14 includes a finger tab 42 that the user can use (e.g., engage, pull, push) to move the battery storage cover between the closed and open positions. The handle 11 includes a tab recess 50 that is sized, shaped, and arranged to receive the finger tab 42 of the battery storage cover 14 when the battery storage cover is in the closed position. More specifically, the tab recess 50 is sized and shaped to enable the finger tab 42 to sit substantially flush with or slightly recessed from an exterior surface 80 of the handle 11 (specifically, gripping section 12), while still enabling a user to access the finger tab 42 for removal of the battery storage cover 14.

The portable scale 10 includes a head 72 (e.g., low-profile head) supported by the handle 11. The head 72 is disposed at the top end of the handle 11. The low-profile head 72 minimizes the overall size, weight, girth, and bulk along the top of the scale, making the scale 10 more compact. The head 72 also provides comfortable ergonomic weight distribution across the thumb and index finger of the user when the user is gripping the gripping section 12. The head 72 expands outwardly of the handle 11 (specifically, gripping section 12) to enable the device 10 to comfortably distribute the weight of a fish during weighing operations across the thumb and index finger of the user. This ergonomic feature enables the device 10 to easily bear the weight of fish weighing operations comfortably across the thumb and index finger. The head 72 expands outwardly of left, right, and rear sides of the handle griping portion to form respective left, right, and rear shoulders that can rest on the thumb, index finger, and/or Purlicue (broadly, web of hand) of the hand of the user to distribute the weight. Other configurations can be used without departing from the scope of the present disclosure.

The head 72 includes a user interface 78 (broadly, the user interface is supported by the handle 11). The user interface 78 includes the display 20 and at least one user input 22, such as, but not limited to, one or more buttons. The user interface 78 is oriented to face rearwardly and upwardly when the handle axis 74 of the handle 11 is oriented generally vertically. Holding the portable scale 10 at any angle other than substantially perpendicular to the load cell 16 (oriented in the gripping section 12 substantially vertically) may produce inaccurate readings. However, the relative orientation of the user interface 78 positions the user interface 78 (specifically, the display 20) to be easily viewable by the user when the user is holding the portable scale 10 in the vertical orientation (the scale 10 is aligned substantially straight up and down (i.e., substantially perpendicular to the load cell 16)). The display 20 comprises a substantially planar screen, such as, but not limited to, a liquid crystal display (LCD), that is oriented substantially normal to the direction the user interface 78 faces when using the scale. The display 20 can display or show information to the user, such as the weight measured by the weight sensor 16.

In one embodiment, an angle θ defined between the direction the user interface 78 faces and the vertical, or the handle axis 74 when the portable scale 10 is held substantially vertically, is within the inclusive range of about 10° to about 60°, or more desirably about 15° to about 50°, or more desirably about 20° to about 40°, or more desirably about 25° to about 35°. In one embodiment, an angle β defined between the direction the user interface 78 faces and the horizontal plane is about 28°. The angular orientation and relationship between the user interface 78 and the handle axis 74 promotes a natural position of the user's shoulders, arms, and torso. More importantly, this orientation does not require elevating the scale to the user's eye level to read the results on the display 20. This relative position also facilitates developing “easy” muscle memory within the user that facilitates repeatable and accurate weights. In addition, the angled orientation also encourages the user to hold the portable scale 10 in the proper vertical orientation, which facilitates accurate weight measurements.

The battery storage cover 14 is removably coupled to the handle 11. In the illustrated embodiment, the battery storage cover 14 sealingly couples with the handle 11 to facilitate providing water-resistant protection for batteries 58 housed within the battery compartment 26. In particular, the battery storage cover 14 is press fit into the handle 11 in a tight tolerance such that a substantially watertight seal is formed between the handle and the battery storage cover to facilitate maintaining the battery compartment 26 watertight. The battery storage cover 14 is separable from the handle 11 and forms an interference fit or friction fit (e.g., around a periphery of the cover) with the handle when in the closed position to form a seal and to remain in the closed position without requiring threaded connections, latching mechanisms, and/or any other complex fastening systems or mechanisms, although such could be provided without departing from the scope of the present disclosure. The battery storage cover 14 is resiliently deformable and is resiliently deformed by the handle 11 to form the interference sealing fit when the battery storage cover is in the closed position.

In the illustrated embodiment, the battery storage cover 14 includes a rigid brace, spline, or support 28 and a shell or cover 30. The brace 28 provides structural support and stiffness to retain the structural rigidity of the battery storage cover 14 when the shell 30 engages, and is slightly deformed and/or compressed by, the handle 11 to form the interference fit. The rigid brace 28 maintains the shape and structural integrity of the battery storage cover 14 during installation and use and thus prevents excessive deformation that could otherwise compromise the seal and/or make removal and/or installation difficult. The shell 30 can be resiliently deformable (e.g., elastomeric). The shell 30 may be made of, but is not limited to only being fabricated from, a thermoplastic elastomer (TPE) material, a rubber material, a silicone material, an elastomeric material, and/or any other suitable material or combination of materials that enables the shell 30 to function as described herein.

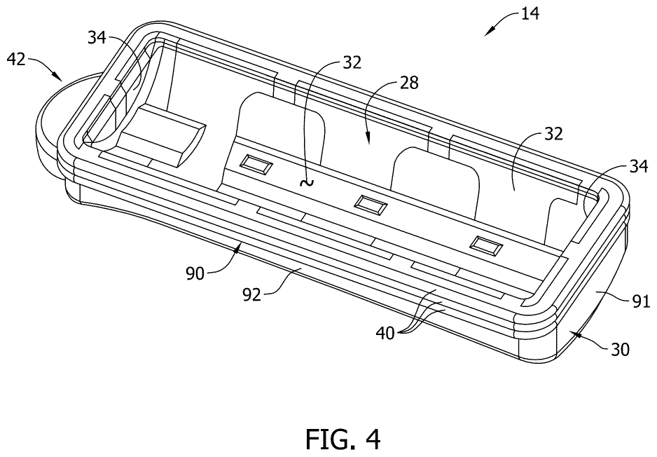

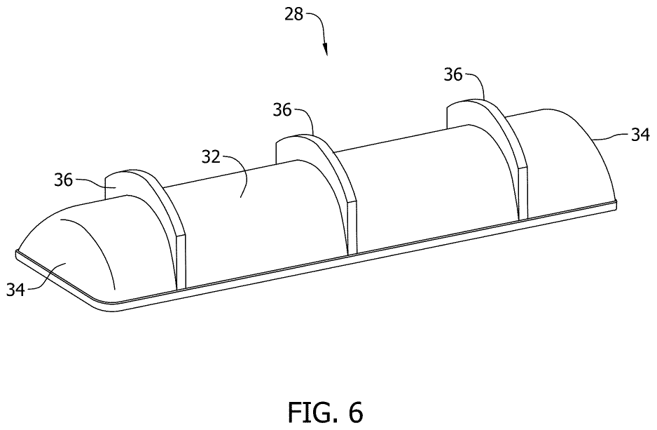

Referring to FIGS. 4 and 6, the rigid brace 28 includes a half-cylindrical wall 32 and a pair of opposed end walls 34. In one embodiment, the half-cylindrical wall 32 has an arcuate shape that is specifically sized and shaped to accommodate at least a portion of the batteries to be housed therein when the battery storage cover 14 is in the closed position. The arcuate shape enables the battery storage cover 14 to receive and to partially enclose at least one battery therein, thus providing protection and securing a relative position of each battery therein. Thus, the battery storage cover 14 has a battery cavity or space 52 sized and shaped to receive at least a portion of the battery or batteries 58 in the battery compartment 26. The arcuate shape of the half-cylindrical wall 32 is shaped to substantially complement the shape of one or more batteries 58.

The battery storage cover 14 is arranged (relative to the gripping section 12) to be engaged by the hand of the user when the hand is grasping the gripping section to support the scale 10 when weighing the object (see FIG. 8). There is a smooth transition between the battery storage cover 14 and the handle's exterior surface 80. When the battery storage cover 14 is located in the handle 11, an outer surface 82 of the battery storage cover 14 is substantially flush with the portion of the outer surface 80 of the handle surrounding the battery storage cover 14 and opening 27. The outer surface 82 of the battery storage cover 14, along with the outer surface 80 of the handle, forms a gripping surface of the grip. The outer or exterior surface 82 of the battery storage cover 14 is formed by the shell 30. The shell 30 can be made out of the same material as the covering 46, to provide a comfortable, non-slip area for the user to grip the gripping section 12. Other configurations can be used without departing from the scope of the present disclosure.

The rigid brace 28 may be formed from any suitable material that enables the battery storage cover 14 to function as described herein. For example, the rigid brace 28 may be fabricated from, but is not limited to only being fabricated from, a plastic material, such as acrylonitrile butadiene styrene (ABS), polycarbonate, polypropylene, Polymethyl Methacrylate (PMMA), Acrylonitrile Styrene Acrylate (ASA), and/or any other engineering polymer and/or combination of materials. In each embodiment, the material is selected to facilitate providing sufficient stiffness to resist deformation when the shell 30 is compressed against the handle 11.

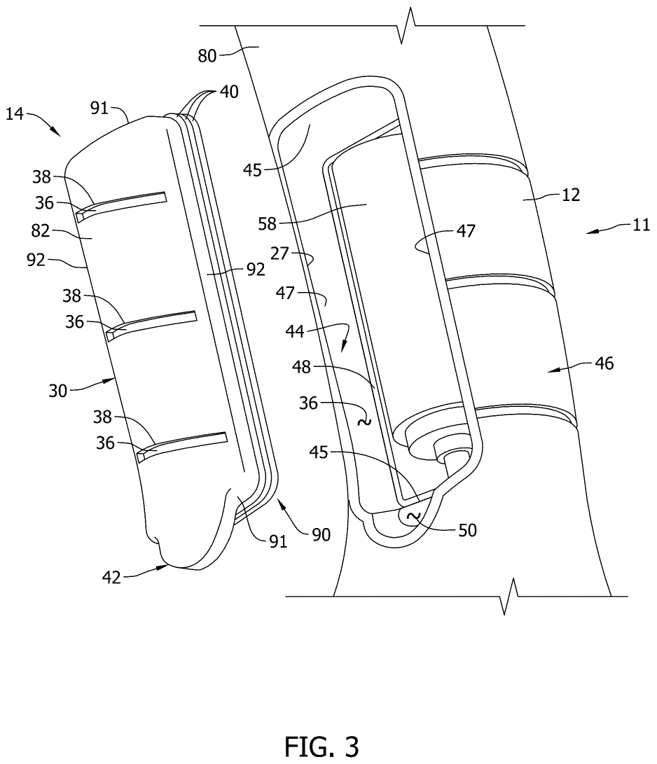

Referring to FIGS. 3, 4, 6 and 7, either the shell 30 and/or the rigid brace 28 includes at least one projection 36 (e.g., interlocking projection), and the other of the shell 30 and the rigid brace 28 includes at least one recess 38 (e.g., interlocking recess) that receives the projection 36 to facilitate securing the shell 30 and the rigid brace 28 together. In one embodiment, the rigid brace 28 includes the projections 36, in the form of ribs, and the shell 30 includes the recesses 38 (e.g., in the form of slots). Each recess 38 is sized and oriented to receive one projection 36 therein such that each projection 36 mechanically interlocks with the shell 30 to facilitate securing the two components together, and to prevent relative movement between them.

The shell 30 surrounds the rigid brace 28 (at least one exterior side thereof). In one embodiment, the shell 30 is molded onto the rigid brace 28. In other embodiments, the shell may be coupled to the rigid brace using any other known fabrication or attachment method that enables the battery storage cover 14 to function as described herein. For example, the battery storage cover 14 may be fabricated using adhesive bonding, mechanical fastening, RF welding, sealants, and/or any other suitable coupling technique and/or fabrication method that enables the battery storage cover 14 to function as described herein.

The battery storage cover 14 forms a watertight seal with the handle 11 when the battery storage cover is in the closed position. The battery storage cover 14 has a compliant seal or gasket 90 that engages and cooperates with the handle 11 in a sealing contact. In the illustrated embodiment, the compliant seal 90 is formed by the shell 30. The material used in fabricating the shell 30 is selected to facilitate providing sufficient flexibility (e.g., resiliently deformable) to allow the compliant seal 90 to compress and form a seal with the handle 11 while maintaining durability and resistance to environmental factors such as water, UV radiation, and temperature variations.

In the illustrated embodiment, the compliant seal 90 comprises a plurality of (broadly, one or more) peripheral interface projections or ribs 40 that are spaced and arranged to engage the handle 11 (specifically, interior surfaces 45, 47 of the rigid body 44 bounding the battery compartment 26) to form the interference fit when the battery storage cover 14 is secured in the closed position. The interface projections 40 project laterally outward from a main body of the shell 30 to engage the handle 11. The peripheral interface projections 40 extend outwardly from an outer periphery of the battery storage cover 14 to facilitate forming a peripheral (e.g., continuous peripheral) sealing ring. Desirably, each interface projection 40 extends completely around the periphery or perimeter of the battery storage cover 14 (specifically, the main body of the shell 30). The interface projections 40 can be made of the same resiliently deformable material of the shell 30. Thus, the interface projections 40 are resiliently deformable. In the illustrated embodiment, the interface projections 40 are integrally formed with the shell 30. Other configurations can be used without departing from the scope of the present disclosure.

Desirably, each interface projection 40 not only forms an interference fit to assist in connecting the cover to the handle but also forms a watertight seal between the battery storage cover 14 and the handle 11 to inhibit water (and other fluids) from flowing between the battery cover and the handle and into the battery compartment 26. Each interface projection 40 (e.g., sealing interface projection) at least partially seals off the battery compartment 26 from the exterior environment. In the illustrated embodiment, the compliant seal 90 includes three peripheral interface projections 40 that are spaced apart in a stack extending along an axis generally parallel to the directions the battery storage cover 14 is inserted into and removed from the battery compartment 26. This axis is perpendicular to a longitudinal axis of the battery storage cover 14. Three projections provide optimal redundancy—if one seal fails, two remain to maintain water resistance, while avoiding excessive compression force that would make installation difficult. The peripheral interface projections 40 provide redundant sealing surfaces, thus ensuring that even if one sealing area is compromised, the remaining sealing areas maintain water resistance. Accordingly, in one embodiment, the peripheral interface projections 40 each act as a gasket that forms the watertight seal between the battery storage cover 14 and the handle 11. Desirably, each sealing interface extends at least partially around the periphery of the cover to form a peripheral seal, and more desirably extends substantially fully around or completely around the periphery of the cover, such as to each form a substantially complete or complete peripheral seal around the cover. Other configurations can be used without departing from the scope of the present disclosure.

The battery storage cover 14 has opposite exterior end surfaces or walls 91 and opposite exterior side surfaces or walls 92 extending between and interconnecting the end surfaces. Each interface projection 40 extends over and along all the end and side surfaces 91, 92. Each interface projection 40 is continuous and free of any interruptions or discontinuities as the projection extends over the end and side surfaces 91, 92. The ends and side surfaces 91, 92 form a generally rectangular footprint of the battery storage cover 14. The footprint of the battery compartment 26 generally matches the footprint of the battery storage cover 14. Thus, the battery compartment 26 also has a generally rectangular footprint. The rigid inner body 44 of the handle 12 has opposite interior end surfaces or walls 45 and opposite interior side surfaces or walls 47 extending between and interconnecting the end surfaces. Each interface projection 40 engages the interior side and end surfaces 45, 47 continuously around the entire perimeter of the battery compartment 26 to form the seal between the battery storage cover 14 and the handle 11.

In the illustrated embodiment, the shell 30 forms the finger tab 42 (e.g., protrusion). The finger tab 42 is sized and oriented to be engaged by a user to pull the battery storage cover 14 from the handle 11 to separate the handle and the battery storage cover. The finger tab 42 provides a gripping surface that enables the user to pull the battery storage cover 14 away from the handle 11 to provide access to the battery compartment 26.

The battery storage cover 14 has a battery compartment or space 52 that is sized and shaped to receive at least a portion of a battery 58 therein when the battery storage cover 14 is in the closed position. In one embodiment, the compartment 52 is variably sized and shaped to receive approximately 50% of the battery's length. In one embodiment, the compartment 52 has an open side that faces into or towards the handle 11 when the battery storage cover 14 is in the closed position. The open side permits the battery to move into (i.e., be inserted into) and/or moved out (i.e., be removed from) the cover compartment 52 when the battery storage cover 14 is moved between the open position (FIG. 5) and the closed position (FIG. 2).

To install the battery storage cover 14, a user aligns the battery storage cover 14 with the opening 27 of the battery compartment 26 and depresses the battery storage cover 14 into the handle 11. As the battery storage cover 14 is pressed into the handle 11, the peripheral interface projections 40 engage the interior surface(s) of the handle (and/or the covering 46 thereof). The peripheral interface projections 40 are slightly compressed or resiliently deformed as they engage the handle 11, creating an interference fit that secures the battery storage cover 14 in place relative to the handle and forms the watertight seal.

The brace 28 maintains the structural integrity of the battery storage cover 14 during this compression and thus prevents excessive deformation that could compromise the seal and/or make removal difficult. The arcuate shape of the rigid brace 28 accommodates a portion of the battery while maintaining the structural rigidity needed to support the interference fit. The interference fit is sufficient to retain the battery storage cover 14 in the closed position during normal use, including when the portable scale 10 is subjected to typical handling forces by a user and/or environmental conditions.

The compression of the peripheral interface projections 40 against the handle 11 creates a watertight seal that substantially prevents water from entering the battery compartment 26. Because the multiple peripheral interface projections 40 are arranged in a stack in one embodiment, the projections 40 provide redundant sealing, thus enhancing the reliability of the water resistance. Further, the batter storage cover 14 can be connected and disconnected to the handle 11 without the use of tools. As a result, the watertight seal is formed without the use of tools (e.g., using a screwdriver to tighten down a screw that in turn compresses a gasket or O-ring).

When the battery storage cover 14 is in the closed position, the exterior surface 82 of the battery storage cover 14 is substantially flush with the exterior surface 80 of the handle. This not only creates an integrated and appealing appearance, it also enables a user to grip the gripping section 12 comfortably without interference from protruding edges or discontinuities. When gripping the gripping section 12, the user's hand extends over both the gripping section 12 and the battery storage cover 14 without any discomfort.

To remove the battery storage cover 14, a user engages the finger tab 42 and pulls the battery storage cover 14 away from the handle 11. The elasticity of the shell 30 enables the peripheral interface projections 40 to flex and release from the handle 11, permitting separation of the battery storage cover 14 from the handle. Once removed, the user has access to the battery compartment 26, such as to replace the one or more batteries 58.

The load cell 16 is supported by the handle 11 and measures the weight of the object (e.g., fish). The load cell 16 (broadly, weight sensor) may include a strain gauge, transducer, or other weight sensing technology. The load cell 16 is positioned to measure the weight of an object (e.g., fish) suspended below the portable scale 10. The portable scale 10 can include an object connection mechanism 84 coupled to the load cell 16 for suspending fish or other objects to be weighed. In the illustrated embodiment, the object connection mechanism 84 comprises a locking plier (e.g., vise-grip), although other types of object connection mechanisms (e.g., hook, clip, jaws, spring-loaded jaws, carabiner, suspended platform, etc.) can be used without departing from the scope of the present disclosure.

The controller 18 is coupled to the load cell 16 to receive weight measurements from the load cell 16. The controller 18 processes the weight measurements and causes the display 20 to show the weight to the user. The controller 18 also manages communication with the wireless transceiver 24 and responds to user inputs from the buttons 22.

The portable scale 10 can communicate with a remote device 56 (e.g., smart device) such as a smartphone, tablet, computer, or any other suitable device. The wireless transceiver 24 of the portable scale 10 communicates with a corresponding wireless transceiver within the remote device 56 to exchange data and control signals in a bi-directional manner. The portable scale 10 employs various communication protocols and/or is capable of employing various communication protocols to facilitate functionality, such as Wi-Fi, Bluetooth, cellular, satellite, and/or via any other wireless protocol. Such communications between the portable scale 10 and the remote device can include, but are not limited to, status updates, fish scale historical records, and/or device configuration data. The portable scale 10 may include multiple wireless transceivers 24. For example, the portable scale 10 may include a short-range wireless transceiver (e.g., Bluetooth, Wi-Fi, or the like) for connectivity to the smart device 56 and a long-range wireless transceiver (e.g., cellular network, satellite network, or the like) for connecting to a remote server (e.g., a cloud server).

The portable scale 10 can be connected to the remote device 56 via the wireless (e.g., Bluetooth) connection. When connected, the portable scale 10 can sync its settings and mode data to an application running on the remote device 56. Mode data may include the current mode, any locked weight, the current bag or cooler total and/or the bag weight (or weights for competition mode). The data may include, but is not limited to only including, any fish in a smart culling system and their indicator or description. The sharing of settings and mode data allows the user to view the settings and mode data with the remote device 56.

The portable scale 10 (e.g., wireless transceiver 24) can also receive a control signal from the remote device 56. This allows the remote device 56 to modify the scale 10. More specifically, this allows the user to use the user interface (e.g., button(s) 62, display 64) of the remote device to change the scale. In particular, the controller 18 is configured to receive the control signal from the remote device 56 via the wireless transceiver 24. The controller 18 of the portable scale 10 can modify at least one of a setting or a mode of the portable scale 10 in response to receiving the control signal. For example, the user can enter information (e.g., a setting, fish identifier, etc.) with the remote device 56 and then the remote device 56 transfers the information to the portable scale 10, which takes an action based on the information.

The remote device 56 can send a control signal to change the units of measurement (e.g., from pounds to kilograms), to adjust the display brightness, to change the weighing mode (e.g., from single fish mode to bag weight mode to culling mode), to reset the bag total, to modify culling parameters, and/or to adjust other operational parameters of the portable scale 10. Adjustments to the setting or the mode may include adjustments to at least one of units of measurement, display brightness, weighing mode, bag total, culling parameters, and/or other operational settings.

For example, the controller 18 changes from a first mode to a second mode in response to receiving the control signal. The first mode can be one of a single weight mode, a bag weight mode, or a rally mode, and the second mode can be a different one of these modes. In the single weight mode, the scale 10 (specifically, controller 18) keeps track of the weight of only one fish at a time. In the bag weight mode, the scale 10 (specifically, the controller), keeps track of the total weight of a set number (e.g., 5, 8, 10, etc.) of fish, the set number of fish forming the “bag.” If the weight of a fish currently being weighed is larger than the smallest weight of a fish already in the “bag” (e.g., a fish previously weighed and whose weight was saved (e.g., added to the bag)), the scale replaces the smallest weight in the “bag” with the current weight (if the set number of fish has already been reached). This automatically updates the “bag” of the fisherman, keeping track of largest weights (e.g., if the set number is 5, keeps track of the five largest weights) the fishermen records in a given time frame (e.g., for that day). In the rally mode, the scale 10 (specifically, controller 18) keeps track of all fish weighed by the scale. In the rally mode, the scale 10 can display a total weight (sum of all the weights). The scale 10 can also display the largest weight and/or the smallest weight. Other modes can be used without departing from the scope of the present disclosure.

In another example, the controller 18 changes a setting of the scale 10 in response to receiving the control signal. The setting can be at least one of a unit of measurement setting (e.g., imperial or metric units), a display brightness setting (e.g., how bright to make the display 20), an auto-lock weight setting (e.g., if this setting is enabled or turned on, the controller 18 will lock or freeze the weight being displayed (and eventually stored) when the weight sensor 16 measures a stable or consistent weight for a period of time (e.g., 2-3 seconds) to avoid having the weight value displayed keep changing slightly, such as due to user movement), a sleep mode setting (e.g., select how much inactive time (e.g., 30 seconds, 1 minute, 5 minutes) for the scale must occur before the scale enters a sleep mode), a bag limit setting (e.g., how many fish are in the “bag” for the bag weight mode), or a clear weight setting (e.g., clear all stored weights).

The syncing is bi-directional, meaning the portable scale 10 is capable of making adjustments to any settings or mode data that the portable scale 10 has based on commands received from the remote device 56. This allows the user to conveniently control and configure the portable scale 10 using the larger display and more intuitive interface of the remote device 56. The bi-directional communication allows the portable scale 10 to both receive control signals from the remote device 56 and transmit weight data to the remote device. Any information sent by the scale 10 to the remote device 56 can be displayed by the remote device via its display 64. The remote device can modify the operational settings and modes of the scale 10 itself, providing greater flexibility and user convenience.

The portable scale 10 can automatically store weight data and transmit the weight data to the remote device 56. When a fish is weighed, the controller 18 obtains the weight measurement from the load-cell 16 and sends the weight measurement via the wireless transceiver 24 to the remote device 56. The controller 18 can do this automatically (as long as the remote device and the scale are communicatively coupled together), without any user interaction or instruction. The portable scale 10 uploads fish data (e.g., weight) with minimal interaction from the user, allowing the user to catch the fish, weigh the fish, have the weight stored, and then repeat for the next fish. The portable scale 10 may also store and transmit to the remote device 56 other information regarding the catch such as the date, location, temperature, etc. In one embodiment, upon receiving the weight of the fish from the scale 10, the remote device 56 determines and associates (e.g., saves) such other information with the weight of the fish. For example, upon receiving a weight of a fish from the scale 10, the remote device can identify and save the temperature, date, location (e.g., GPS coordinates), etc. of the catch. The remote device 56 may include a GPS sensor that provides location, may have an internal calendar and clock that provides the date and time, and may communicate with a remote server (e.g., weather app) for the temperature. All this information about the catch is captured without any manual entry required by the user. For example, when a new fish is weighed and added to a bag, the portable scale 10 will continue to sync data to the application on the remote device 56. The remote device 56 may run an application that displays and manages the weight data, allowing users to track their catches over time.

The remote device 56 includes a power supply 59 (e.g., rechargeable battery), a controller 60 (e.g., a processor) that runs the application, receives user input from a user input 62 (e.g., buttons, touch-screen display, etc.), outputs to a display 64 (e.g., touch-screen display), sends and receives data via wireless transceivers 66, and stores and recalls data from memory 68. The display 64 can be a touch screen. In one embodiment, the remote device 56 also includes a camera 70 for taking pictures of fish. The one or more wireless transceivers 66 may include a short-range wireless transceiver (e.g., Bluetooth, Wi-Fi, or the like) for connectivity to the portable scale 10 and a long-range wireless transceiver (e.g., cellular network, satellite network, or the like) for connecting to a remote server (e.g., cloud server).

The controller 18 (broadly, a computer) controls the operation of the scale 10. The controller 18 controls and operates the components (e.g., weight sensor, user interface, etc.) of the scale 10. The controller 18 has control circuity which includes a CPU or processor (e.g., a launcher processor) that communicates with a RAM or memory 21 (broadly, non-transitory computer readable storage medium). Broadly, the memory 21 includes (e.g., stores) processor-executable instructions for controlling the operation of the scale 10 and the components thereof. The instructions embody one or more of the functional aspects of the scale 10 and the components thereof (as described herein), with the processor executing the instructions to perform said one or more functional aspects. The components of the scale 10 may be in wired or wireless communication with the controller 18. The controller 18 and memory 21 can be provided on a circuit structure, such as one or more printed circuit boards (PCBs). Other controller configurations can be used without departing from the scope of the present disclosure.

Although described in connection with an example computing system environment, embodiments of the aspects of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the example operating environment. Examples of well-known computing systems, computing circuitry, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers, which include computing circuitry, may execute the processor-executable instructions (e.g., software, firmware, and/or hardware) such as those illustrated herein to implement aspects of the disclosure.

Embodiments of the aspects of the disclosure may be implemented with processor-executable instructions. The processor-executable instructions may be organized into one or more processor-executable components or modules on a tangible processor readable storage medium. Aspects of the disclosure may be implemented with any number and organization of such components or modules. For example, aspects of the disclosure are not limited to the specific processor-executable instructions or the specific components or modules illustrated in the figures and described herein. Other embodiments of the aspects of the disclosure may include different processor-executable instructions or components having more or less functionality than illustrated and described herein.

The order of execution or performance of the operations in embodiments of the aspects of the disclosure illustrated and described herein is not essential, unless otherwise specified. That is, the operations may be performed in any order, unless otherwise specified, and embodiments of the aspects of the disclosure may include additional or fewer operations than those disclosed herein. For example, it is contemplated that executing or performing a particular operation before, contemporaneously with, or after another operation is within the scope of aspects of the disclosure.

Although the present disclosure is described and illustrated herein with respect to a fish scale 10, it is understood the teachings herein can be applied to other devices. For example, aspects of the battery storage cover disclosed herein can be used with other portable handheld devices having battery compartments (e.g., watertight battery compartment), such as handheld GPS devices, marine radios, outdoor measurement tools, or other outdoor equipment where watertight battery compartment sealing is desired.

Example technical effects of the portable fish scale and battery storage cover system described herein include, for example: (a) providing a low-profile head with an angled display that promotes proper vertical holding orientation while enabling comfortable viewing without requiring the user to elevate the scale to eye level; (b) providing a battery storage cover with a two-component construction comprising a rigid brace and elastomeric shell that forms a watertight interference fit without requiring threaded connections or latching mechanisms; (c) providing peripheral interface projections arranged in a stack that create redundant sealing surfaces for enhanced water resistance; (d) providing an arcuate rigid brace that accommodates a portion of the battery while maintaining structural integrity during compression; (e) providing a finger tab that enables tool-free removal and installation of the battery storage cover for convenient battery replacement; (f) providing bi-directional wireless control capability that allows a remote device to modify operational settings and modes of the scale; and/or (g) providing ergonomic contours and an outward-swelling top portion that distributes weight comfortably across the user's thumb and index finger.

Example embodiments of a portable fish scale with an ergonomic battery storage cover and angled display are described above in detail. The portable scale is not limited to the specific embodiments described herein, but rather, components of the scale and/or steps of the methods may be utilized independently and separately from other components and/or steps described herein. For example, the battery storage cover configuration with its two-component construction and peripheral interface projections may also be used in combination with other portable weighing devices, handheld tools, or outdoor equipment where watertight battery compartment sealing is desired. Similarly, the low-profile head with angled display may be implemented in other handheld measurement devices. The example embodiments can be implemented and utilized in connection with many applications where ergonomic design, water resistance, and wireless control of portable weighing devices are desired.

In the specification and the claims, reference is made to a number of terms, which shall be defined to have the following meanings. The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, “low-profile head” refers to a head portion of the scale that has a compact form factor with minimized bulk, weight, and girth compared to conventional fish scale housings, while still providing necessary functionality including display and user input interfaces.

As used herein, “watertight” means substantially preventing water ingress under normal use conditions, including resistance to splashing, rain, and brief submersion (e.g., submersion to 1 meter depth for up to 30 minutes).

Although specific features of various embodiments of the present disclosure may be shown in some drawings and not in others, this is for convenience only. In accordance with the principles of the present disclosure, any feature of a drawing may be referenced and/or claimed in combination with any feature of any other drawing.

This written description uses examples to disclose the embodiments of the present disclosure, including the best mode, and also to enable any person skilled in the art to practice the disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The patent claims at the end of this document are not intended to be construed under 35 U.S.C. § 112(f) unless traditional means-plus-function language is expressly recited, such as “means for” or “step for” language being expressly recited in the claim(s).

Although specific features of various embodiments may be shown in some drawings and not in others, this is for convenience only. In accordance with the principles of the systems and methods described herein, any feature of a drawing may be referenced or claimed in combination with any feature of any other drawing.

The detailed description illustrates the disclosure by way of example and not by way of limitation.

What is claimed is:

1. A handheld scale comprising:
a handle having a battery compartment, the handle having a gripping section configured to be grasped by a hand of a user to support the scale when weighing an object;
a head supported by the handle, the head including a display;
a weight sensor supported by the handle, the weight sensor configured to measure a weight of the object; and
a battery storage cover moveable between a closed position where the battery storage cover closes the battery compartment and an open position where the battery storage cover is arranged to permit access to the battery compartment, the battery storage cover being arranged to be engaged by the hand of the user when the hand is grasping the gripping section to support the scale when weighing the object.

2. The handheld scale of claim 1, wherein the battery storage cover forms a watertight seal with the handle when the battery storage cover is in the closed position.

3. The handheld scale of claim 1, wherein the battery storage cover forms an interference fit with the handle to secure the battery storage cover in the closed position.

4. The handheld scale of claim 3, wherein the battery storage cover is resiliently deformable and is resiliently deformed by the handle to form the interference fit when the battery storage cover is in the closed position.

5. The handheld scale of claim 4, wherein the battery storage cover includes a resiliently deformable interface projection configured to engage the handle to form the interference fit when the battery storage cover is in the closed position.

6. The handheld scale of claim 5, wherein the interface projection extends around a perimeter of the battery storage cover.

7. The handheld scale of claim 6, wherein the interface projection projects laterally outward to engage the handle.

8. The handheld scale of claim 5, wherein the interface projection is a first interface projection, wherein the battery storage cover includes a second resiliently deformable interface projection configured to engage the handle to form the interference fit when the battery storage cover is in the closed position.

9. The handheld scale of claim 5, wherein the interface projection forms a watertight seal between the battery storage cover and the handle to inhibit water from flowing between the battery storage cover and the handle and into the battery compartment.

10. The handheld scale of claim 5, wherein the battery storage cover includes a rigid brace and a resiliently deformable cover overlying the rigid brace, the cover forming the interface projection.

11. The handheld scale of claim 10, wherein one of the rigid brace and the cover includes an interlocking projection and the other of the rigid brace and the cover includes an interlocking recess that receives the interlocking projection to secure the cover and the rigid brace together.

12. The handheld scale of claim 1, wherein an exterior surface of the battery storage cover is flush with an exterior surface of the gripping section when the battery storage cover is in the closed position.

13. The handheld scale of claim 1, wherein the battery storage cover is free from connection to the handle when the battery storage cover is in the open position.

14. The handheld scale of claim 1, wherein the battery storage cover includes a finger tab configured to be engaged by the user to move the battery storage cover between the closed and open positions.

15. The handle scale of claim 14, wherein the handle has a finger tab recess sized, shaped, and arranged to receive the finger tab of the battery storage cover when the battery storage cover is in the closed position.

16. A handheld scale comprising:
a handle having a battery compartment, the handle having a gripping section configured to be grasped by a hand of a user to support the scale when weighing an object;
a head supported by the handle, the head including a display;
a weight sensor supported by the handle, the weight sensor configured to measure a weight of the object; and
a battery storage cover moveable between a closed position where the battery storage cover closes the battery compartment and an open position where the battery storage cover is arranged to permit access to the battery compartment, the battery storage cover being configured to form an interference fit with the handle for locating the battery storage cover relative to the handle in the closed position, the interference fit creating a seal to obstruct water from entering the battery compartment past the seal.

17. A handheld scale comprising:
a handle configured to be grasped by a hand of a user to support the scale when weighing an object;
a weight sensor supported by the handle, the weight sensor configured to measure a weight of the object;
a user interface supported by the handle, the user interface including a display configured to display the weight measured by the weight sensor;
a wireless communication port for communicating with a remote device; and
a controller configured to receive a control signal from the remote device via the wireless communication port, the controller configured to modify at least one of a setting or a mode of the handheld scale in response to receiving the control signal.

18. The handheld scale of claim 16, wherein the controller is configured to change from a first mode to a second mode in response to receiving the control signal.

19. The handheld scale of claim 17, wherein the first mode is one of a single weight mode, a bag weight mode, or a rally weight mode, and the second mode is a different one of the single weight mode, a bag weight mode, or a rally weight mode.

20. The handheld scale of claim 16, wherein the controller is configured to change a setting in response to receiving the control signal, wherein the setting is at least one of a unit of measurement setting, display brightness setting, auto-lock weight setting, sleep mode setting, bag limit setting, or clear weight setting.
